(19) United States
(12) Patent Application Publication
(10) Pub. No.: US 2015/0079297 A1
(43) Pub. Date: Mar. 19, 2015

(54) METHOD OF COATING A FIBER WITH PRE-COATING

(71) Applicants: SNECMA, Paris (FR); CENTRE NATIONAL DE LA RECHERCHE SCIENTIFIQUE, Paris (FR); UNIVERSITE DE BORDEAUX 1, Talence (FR); INSTITUT POLYTECHNIQUE DE BORDEAUX, Talence (FR)

(72) Inventors: Jean-Michel Patrick, Maurice Franchet, Paris (FR); Gilles Charles, Casimir Klein, Mery Sur Oise (FR); Gerald Sanchez, Dingy St Clair (FR); Yann Le Petitcorps, Leognan (FR); Eric Arquis, Merignac (FR); Delphine Vermaut, Lezat Sur Leze (FR)

(73) Assignees: SNECMA, Paris (FR); CENTRE NATIONAL DE LA RECHERCHE SCIENTIFIQUE, Paris (FR); UNIVERSITE DE BORDEAUX 1, Talence (FR); INSTITUT POLYTECHNIQUE DE BORDEAUX, Talence (FR)

(21) Appl. No.: 14/390,920

(22) PCT Filed: Apr. 5, 2013
(86) PCT No.: PCT/FR2013/050752

§ 371 Date: Oct. 6, 2014

(30) Foreign Application Priority Data
Apr. 6, 2012 (FR) 1201042

(51) Int. Cl. C04B 41/45; C23C 2/26; C04B 35/565; C23C 2/04; C04B 41/90; C04B 41/88

(52) U.S. Cl. CPC C04B 41/4523; C04B 41/90; C04B 41/88; C04B 35/565; C23C 2/04; C04B 41/4584; C23C 2/26
USPC 427/398.1

(57) ABSTRACT

A method of depositing a coating of a first metal alloy on a fiber extending in a main direction, including: a) heating a first mass of a first metal alloy above its melting temperature; and b) moving the fiber through the liquid first mass to be covered by a coating of a non-zero thickness over the entire periphery of the fiber; and prior to a): i) providing a second mass of a second metal alloy having a higher melting temperature than the first alloy; j) heating the second mass to above its melting temperature to be in its liquid state and then moving the fiber through the second alloy such that the second alloy is taken up under visco-capillary conditions and the fiber becomes covered over a portion by a coating of the second alloy of non-zero thickness; and k) cooling the second coating until it becomes solid.

The present invention lies in the field of fabricating parts out of metal matrix composite material. The invention relates to a method of depositing a coating of a first metal alloy on a fiber extending in a main direction D, the method comprising the following steps:

a) providing a first mass of a first metal alloy and heating the first mass to above its melting temperature so that this alloy is in the liquid state and occupies a space E; and

b) causing the fiber to move in translation from upstream to downstream through the liquid first mass along the direction in which the fiber extends at a first speed V1 such that the fiber becomes covered over at least a portion of its length by a coating of the first alloy, which coating presents a non-zero thickness over the entire periphery of the fiber in a plane perpendicular to the main direction D.

In certain applications, in particular in aviation for turbine engine parts, parts made of metal matrix composite material reinforced by fibers, e.g. ceramic fibers, present very considerable potential.

Such composites present performance in terms of stiffness and mechanical strength that is high, with the fiber reinforcement enabling weight to be saved compared with a part of equivalent performance but made of the same metal alloy without fiber reinforcement.

Such a composite is fabricated from a semi-finished product constituted by fiber reinforcement coated in a metal coating forming a sheath around the fiber. The alloy of the metal coating is the same as the alloy of the matrix in which the fibers sheathed in this way are to be embedded during the subsequent manufacturing step.

In order to coat the fiber in the metal alloy, it is possible for example to deposit the alloy by chemical vapor deposition in an electric field, by thermal evaporation, or by electrophoresis from a metal powder.

In the description below, the terms “upstream” and “downstream” are defined relative to the direction in which the fiber moves in translation.

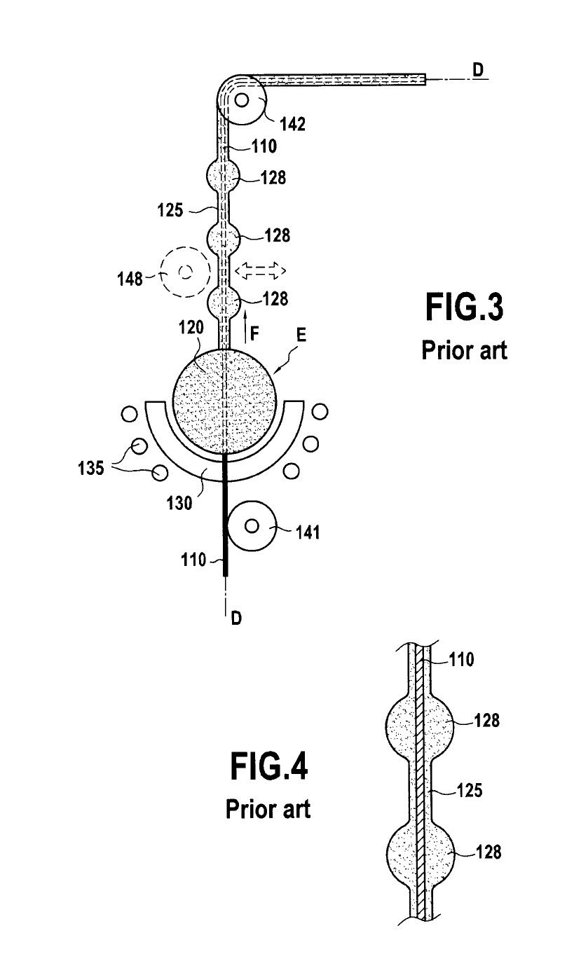

Patent EP 0 931 846 describes a method of depositing alloy on a fiber by a liquid technique (referred to as “coating” the fiber). That device is described with reference to FIG. 3.

A mass 120 of the alloy is heated until it becomes liquid, and then a fiber 110 is moved in translation along its main direction (central axis of the fiber) through the liquid mass 120. The fiber 110 extends between an upstream pulley 141 and a downstream pulley 142 that is situated on either side of the mass 120, with the fiber being suitable for traveling relative to the pullies. In order to avoid leaving the fiber 110 in contact with the molten metal alloy 120 for too long with the risk of damaging it, the fiber 110 is initially held away from the alloy mass 120 while the mass 120 is being heated by using a pulley 148 that is situated on the portion of the fiber 110 that extends between the upstream pulley 141 and a downstream pulley 142. The fiber 110 thus does not touch the alloy mass 120. Once the mass 120 is liquid, the fiber 110 is caused to travel between the two pulleys from the upstream pulley 141 towards the downstream pulley 142, and the fiber 110 is moved progressively towards the alloy mass 120 by moving the pulley 148 in translation until the fiber 110 comes into contact with the mass 120, as shown in FIG. 3 (the double-headed horizontal arrow shows the movement in translation of the pulley 148, which pulley no longer touches the fiber 110 at the end of its movement). The portion of the fiber 110 that has passed through the liquid mass 120 then becomes covered by an alloy coating 125 of given thickness.

In that technology, the liquid mass 120 is kept levitated in a crucible 130 in which it is heated by a heater 135, thereby presenting the advantage that the alloy mass 120 is not contaminated by the material constituting the crucible 130.

That method nevertheless presents drawbacks. In order to obtain an alloy coating 125 on the fiber within a certain range of thicknesses (e.g. thicknesses of about 50 micrometers (μm)), it is necessary for the fiber 110 to pass through the liquid mass 120 of alloy at a high speed. Unfortunately, when the speed of the fiber 110 through the liquid mass 120 of alloy is too fast (more than several meters per second), the time of contact between the fiber 110 and the alloy is too short for the fiber to be completely wetted by the liquid alloy, thereby having the consequence of preventing the fiber 110 from penetrating into the alloy mass 120, such that the fiber 110 remains at the periphery of the alloy mass 120. Thus, by that method, at most approximately three-fourths of the periphery of the fiber 10 becomes coated (three-fourths in a cross-section plane perpendicular to the rectilinear fiber).

In order to improve the wetting of the fiber 110 at high speeds, one solution consists in depositing a compound that is wettable by the metal of the alloy on the fiber 110 by means of reactive chemical vapor deposition (RCVD). That method is described in patent FR 2 891 541.

It is then possible to cause the fiber 110 to pass through (the middle) of the alloy mass 120, as shown in FIG. 3, and to obtain a deposit of alloy on the fiber 110.

Nevertheless, that method presents drawbacks. Specifically, sporadic alloy-expulsion phenomena occur at the exit from the mass 120, thereby leading to droplets of alloy becoming formed on the fiber 110 at more or less regular intervals.

This situation is shown in FIG. 4, which shows a fiber 110 in longitudinal section on exiting the alloy mass 120, together with droplets 128.

Such droplets 128 are undesirable, in particular because they prevent fibers 110 being distributed uniformly within the composite material once they are embedded in the matrix. Furthermore, they lead to the fiber breaking when they reach the downstream pulley 142.

The present invention seeks to remedy those drawbacks.

The invention seeks to provide a method enabling the formation of these droplets to be prevented while continuing to ensure that the fiber passes through the alloy mass, even at high speeds.

This object is achieved by the fact that, prior to step a), the following steps are performed:

i) providing a second mass of a second metal alloy having a melting temperature T_{F2} that is strictly higher than the melting temperature T_{F1} of the first alloy;

j) heating the second mass to above its melting temperature so that the second alloy is in the liquid state and occupies a space E2, and then moving the fiber in translation from upstream to downstream through the second alloy, this translation taking place at a second speed V2 which is such that the condition under which the second alloy is taken up during this translation lies under visco-capillary conditions, such that the fiber becomes covered, over this portion of its length, by a coating of the second alloy, which coating presents a non-zero thickness over the entire periphery of the fiber; and

k) cooling the coating of the second alloy until it becomes solid.

By means of these provisions, since the fiber is coated in the second alloy, it is well wetted by the first alloy on passing through the first alloy, and the coating of first alloy on the fiber is of thickness that is uniform along the entire fiber, without droplets being formed. It is thus possible to coat a fiber with the first alloy even at high speeds (faster than 1 meter per second (m/s)), with a desired coating thickness, and with good adhesion of the coating, and good soundness for the fiber as coated in this way.

Advantageously, the second alloy does not form embrittling phases with the first alloy.

Thus, the second alloy and the first alloy present between them adhesion that is strong and tough, and the resulting composite tends to be stronger.

The invention can be well understood and its advantages appear better on reading the following detailed description of an implementation shown by way of non-limiting example. The description refers to the accompanying drawings, in which:

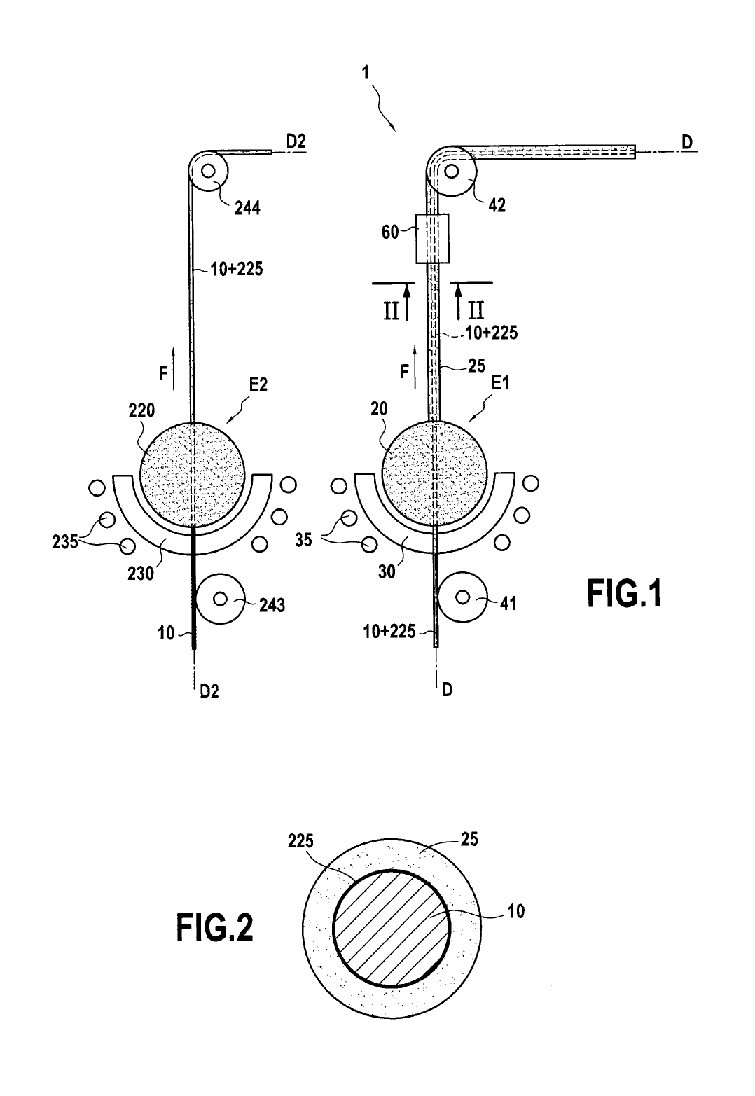

FIG. 1 is a diagrammatic view of a device using the method of the invention for covering a fiber by a liquid alloy;

FIG. 2 is a section on line II-II of FIG. 1 showing a fiber coated in alloy by using the method of the invention;

FIG. 3, described above, is a diagrammatic view of a device using the prior art method for covering a fiber by a liquid alloy; and

FIG. 4, described above, is a longitudinal section of a fiber coated in an alloy by using the prior art method.

There follows a description of the method of the invention for coating a fiber 10.

By way of example, the fibers 10 are made of ceramic.

In particular, the fibers 10 are made of silicon carbide (SiC) surrounding a core of tungsten or of carbon.

In general, each fiber 10 presents a pyrolitic carbon layer having a thickness of a few micrometers. This layer is advantageous since firstly it protects the SiC fiber chemically by acting as a diffusion barrier between the SiC fiber and the metal material external to the fiber, which material is often highly reactive, and secondly it protects the SiC fiber mechanically against the propagation of microdefects by limiting the effects of a nick and making it possible to avoid possible cracking, mainly as a result of the stratified configuration of the fine layer of pyrolitic carbon (see description below).

The term “coating” is used to mean depositing an alloy on a substrate as a result of moving the substrate (here a fiber) in contact with the alloy while the alloy is in liquid form, the alloy being solid at ambient temperature. The term “alloy” is used to include a pure metal, i.e. a metal that (ignoring trace elements) is constituted by a single element from the periodic table of the element (Mendeleev's table).

A certain quantity (a first mass) of a first alloy is provided, and this first mass 20 of this first alloy is heated until it is liquid (step a)).

This heating is performed by placing a quantity of this first alloy in a container, e.g. a crucible 30, and heating it by means of a heater 35 until the temperature throughout the first alloy is higher than its melting temperature T_{F1}. In known manner, the liquid first mass 20 of this first alloy is kept levitated in the crucible 30, thus presenting the advantage that the first mass 20 does not touch the crucible 30 and is therefore not contaminated by the material from which the crucible 30 is made.

By way of example, the heater 35 is an inductor arranged around the crucible 30, the inductor also keeping the first mass 30 of this first alloy in levitation.

Once liquid, this first mass 20 occupies a space E1, i.e. the first mass 20 completely fills this space E1, but does not extend beyond it.

If the first alloy is not a pure metal, then the melting temperature T_{F} is the liquidus temperature for the particular composition of the alloy.

By way of example, the first metal alloy is a titanium alloy.

For example, this first alloy may be Ti-6242 having the following composition by weight:

6%Al+2%Sn+4%Zn+2%Mo

the balance being Ti.

A fiber 10 is placed in such a manner as to extend between an upstream pulley 41 and a downstream pulley 42, between which it is suitable for traveling from the upstream pulley 41 towards the downstream pulley 42 in a direction given by arrow F in FIG. 1.

The fiber 10 thus moves in translation along the main direction D in which it extends, in such a manner that between a first instant t1 and a subsequent instant t2 an arbitrary first section S1 of the fiber 10 (other than its downstream end) moves so as to occupy at the subsequent instant t2 the position that was occupied at the first instant t1 by a second section S2 of the fiber 10 situated downstream from the first section S1.

Between two pulleys, the fiber 10 is tensioned and therefore extends along a main direction D that is the same for each cross-section of the fiber 10. For other portions of the fiber 10, the fiber 10 need not necessarily be rectilinear and its main direction D may vary along the fiber 10, e.g. the fiber 10 (and its main direction) follows a circular arc around a pulley. The upstream pulley 41 is situated upstream from the mass 20 and the downstream pulley 42 is situated downstream from the first mass 20.

The upstream pulley 41 and the downstream pulley 42 form part of a drive mechanism 40 for driving the fiber 10, the fiber 10 being driven for example by a motor (not shown) included in the drive mechanism 40.

The upstream pulley 41 and the downstream pulley 42 are positioned in such a manner that when the fiber extends in rectilinear manner from one pulley to the other (i.e. when it extends along a straight line interconnecting these two pulleys), the fiber 10 passes through (the middle) of the first mass 20 of the first alloy, and thus through the space E1 (step b)).

The drive mechanism 40 may include a guide mechanism other than pulleys for guiding the fiber 10, providing the fiber 10 passes through the first mass 20 as described above.

Advantageously, the main direction D of the fiber 10 is constant (the fiber 10 is rectilinear) between a point upstream from the space E1 and a point downstream from the space E1. The fiber thus tends to conserve a rectilinear shape once it has been coated.

In order to coat the first alloy on a portion of the length of the fiber 10 (e.g. the majority thereof), this portion is caused to pass through the first mass 20 and the space E1 as described above. A coating 25 of first alloy is then deposited on the fiber 10.

The fiber 10 passes through the first mass 20 of alloy at a first speed of translation V1. In the method of the invention, this first speed V1 is high, e.g. faster than 2 m/s.

In the invention, before coating the fiber 10 as described above, the fiber 10 is subjected to pre-coating (steps i), j), and k)).

This pre-coating is performed in a manner similar to the above-described coating, but nevertheless with differences.

Firstly, the pre-coating takes place through a second liquid mass 220 of a second alloy that is different from the first alloy of the first mass 20. The second alloy thus differs in composition from the first alloy, i.e. it is not made up of the same chemical elements, or it is made up of the same chemical elements but in different proportions.

Furthermore, this pre-coating takes place at a speed of translation V2 (second speed V2) that is such that the condition under which the second alloy is taken up during this translation lies under visco-capillary conditions of taking-up of the alloy by the fiber 10. Such visco-capillary conditions correspond to the situation in which the thickness of the alloy that is taken up by a fiber (i.e. that becomes deposited on and that remains on the fiber—this being then called the taking-up of the alloy) is proportional to the two-thirds power of the speed V (i.e. proportional to V^{2/3}). The thickness of the alloy that is taken up is small, being of the order of a few micrometers (μm).

Advantageously, the coating speed V1 is strictly faster than the pre-coating speed V2, i.e. the pre-coating speed V2 is strictly slower than the coating speed V1. It is thus possible to deposit a coating of first alloy of desired thickness on the fiber 10, e.g.

thickness of the order of 50 μm, and to do so without droplets forming along the fiber 10.

For example, the speed V2 is equal to 1 m/s or slower.

In certain configurations, it is desired for the volume fraction of fibers 10 in the final composite material (i.e. after the fibers 10 have become embedded in the metal matrix) to be as high as possible, in order to obtain superior mechanical performance. For this purpose, the total thickness of the coating deposited on the fiber 10 during the pre-coating and during the coating should be as small as possible. To obtain a thickness of first alloy 25 (as deposited during coating) that is as slow as possible, the first speed V1 should be as small as possible. The speed V1 is then under certain circumstances slower than the second speed V2, and lies within visco-capillary conditions.

FIG. 1 is a diagram showing the fiber 10 being subjected to this method of being pre-coated with the second alloy, the second mass 220 of the second alloy being situated in a crucible 230 heated by a heater 235 to a temperature higher than its melting temperature T_{F2}.

The fiber 10 is tensioned between a third pulley 243 situated upstream from the second mass 220 and a fourth pulley 244 situated downstream from the second mass 220. The fiber is moved in translation from the upstream pulley 243 to the downstream pulley 244 and it passes through the second mass 220 of the second alloy, which mass occupies a space E2. The fiber extends along a main direction D2.

While the second mass 220 of alloy is being heated, the portion of the fiber 10 between the third pulley 243 and the fourth pulley 244 is held away from the mass 20 of alloy by an intermediate pulley (not shown), after which it is moved towards the second mass 220 of alloy (in a method similar to that for the pulley 148 described with reference to FIG. 3).

Given that the second speed V2 lies in visco-capillary conditions, the fiber 10 is well wetted by the second alloy, and the fiber penetrates fully into the second mass 220. On leaving the second mass 220, the fiber 10 presents a coating 225 of second alloy of thickness that is substantially constant over its entire circumference and over the entire length of the portion that is to be coated. This thickness is small relative to the diameter of the fiber 10, i.e. less than one-tenth of this diameter.

Once the entire portion of fiber 10 that is it desirable to coat has become coated in the second alloy, the coating is allowed to cool so that it becomes solid (step k)).

In order to accelerate this cooling, it is advantageous to use a cooler that cools the second alloy on this portion of fiber 10.

The cooler is thus situated on the path of the fiber 10 downstream from the space E2 (and upstream from the subsequent coating device, and possibly from the fourth pulley 244, such that the second alloy is solid when it comes into contact with the fourth pulley 244).

By way of example, the cooler is a sheath through which the fiber 10 passes, and it delivers a stream of gas or air (e.g. at ambient temperature) filling the inside of the sheath and in which the fiber 10 is immersed so as to be cooled.

Thereafter the fiber 10, as already coated in this coating 225 of the second alloy, is coated in the first alloy. For this purpose, the fiber 10 is caused to pass through the first mass 20 of the alloy at a speed V1, using the method described above.

On exiting the first mass 20, the coating 225 of second alloy on the fiber 10 presents a coating 25 of a substantially constant thickness of the first alloy over its entire circumference and along the entire length of the portion that is to be coated.

Given that the downstream pulley 42 is touched by the fiber 10 carrying the coating 25, it is necessary for the coating 25 to be solid when it comes into contact with the downstream pulley 42.

After coating, in order to cool the coating 25 sufficiently for it to be solid when it comes into contact with the downstream pulley 42, a cooler 60 is used, which cooler is then situated downstream from the space E1 and upstream from the pulley 42. By way of example, the cooler is similar to the above-described cooler downstream from the pre-coating operation.

The second alloy presents a melting temperature T_{F2} that is higher than the melting temperature T_{F1} of the first alloy.

Surprisingly, tests undertaken by the inventors have shown that when the melting temperature T_{F2} of the second alloy is lower than the melting temperature T_{F1} of the first alloy, the coating 25 of the first alloy and the fiber 10 run the risk of being embrittled. Furthermore, the coating 25 of first alloy does not wet the surface of the coating 225 of second alloy in uniform manner, i.e. certain portions of the coating 225 of second alloy are not covered by the first alloy.

This is due to the fact that while passing through the mass of the first alloy (coating), the second alloy is heated to above its melting temperature T_{F2} and the second alloy (as deposited during pre-coating) remelts and becomes dissolved in the first alloy, and the second alloy shrinks by the capillary effect, thereby laying bare the surface of the fiber 10. Furthermore, since the second alloy is in liquid form, it reacts with the first alloy, which is likewise in liquid form, so as to form chemical compounds that, during subsequent cooling of the first and second alloys, serve to embrittle the coating 25 of the first alloy and to embrittle the fiber 10.

For example, for a fiber made of silicon carbide (SiC) that is to be embedded in a matrix of Ti-6242 titanium alloy (first alloy) having a melting temperature T_{F1} of 1670° C., and with a second alloy of zirconium-vanadium Zr—V with a melting temperature T_{F2} of 1500° C., it is observed after pre-coating (step k)) that carbides (Zr, Ti—C) form during coating (step b)) around the fiber 10 and at the old β grain boundaries of the titanium first alloy.

These carbides embrittle the coating 25 of first alloy. Furthermore, remelting the coating 225 of second alloy tends to embrittle the fiber 10.

Surprisingly, tests undertaken by the inventors have shown that when the melting temperature T_{F2} of the second alloy is equal to the melting temperature T_{F1} of the first alloy, i.e. when the second alloy and the first alloy are identical, the fiber 10 is not completely covered by alloy.

This is due to the fact that the layer of alloy deposited on the fiber 10 during pre-coating is thin (because of the low speed at which the fiber passes through the alloy) and tends to fracture during subsequent cooling. In addition, this layer can become dissolved during the subsequent coating operation. Consequently, the coating that is performed subsequently is not effective, with regions of the fiber 10 that are laid bare being poorly wetted.

For example, for a fiber made of silicide carbide (SiC) that is to be embedded in a matrix made of Ti-6242 titanium alloy, after the pre-coating, a brittle layer of TiC is formed on the surface of the fiber 10. During subsequent cooling, this layer breaks because of its small thickness. Decohesion thus occurs between the fiber 10 and the coating 225 of the second alloy, leaving regions of the fiber 10 that are bare. These bare regions of the fiber 10 are poorly wetted during the coating operation, and consequently the fiber 10 is not covered by alloy in some locations.

In contrast, when pre-coating is performed with a second alloy having a melting temperature T_{F2} that is strictly higher than the melting temperature T_{F1} of the first alloy used during the subsequent coating operation, then a coating 25 of first alloy is obtained that is of uniform thickness over the entire surface of the coating 225 of second alloy that covers the fiber 10, i.e. over the entire periphery of the fiber 10 in a plane perpendicular to the main direction D.

This situation is shown in FIG. 2 which is a cross-section of the fiber 10 (i.e. a section in a plane perpendicular to the direction in which this portion of the fiber 10 extends (main direction D)) after it has been coated.

During pre-coating, the second alloy wets the fiber 10 well since the second speed V2 is slow.

During subsequent coating through the first alloy, the first alloy wets the second alloy coating 225 well and a first alloy coating 25 of uniform thickness becomes formed over the entire surface of the second alloy coating 225, which coating adheres thereto. Because the melting temperature T_{F2} of the alloy is higher than the melting temperature T_{F1} of the first alloy, the coating 225 of the second alloy remains solid throughout coating, thereby protecting the fiber 10. When present, the pyrolytic carbon layer at the surface of the fiber 10 is not damaged during this coating operation.

Thus, the wetting of the fiber 10 by the first alloy is improved relative to a prior art method without pre-coating, thereby enabling the fiber 10 to penetrate fully into the first mass 20 of alloy even at speeds that are fast (several meters per second), thereby covering the fiber over its entire surface without forming droplets.

Advantageously, the second alloy (of the pre-coating) does not form embrittling phases with the first alloy (of the coating).

Thus, the interface between the coating of the second alloy and the coating of the first alloy does not present any phases (i.e. metallurgical phases or compounds) that embrittle this interface, and there is no risk of the interface becoming a zone that generates breaks or decohesion between these coatings.

For example, the second alloy (of the pre-coating) contains at least one chemical element that is present in the first alloy (of the coating).

Thus, the matrix of the composite (which matrix is made of the first alloy) is not modified chemically in harmful manner in the vicinity of the fiber 10

Alternatively, the chemical element has a beta-generating effect on titanium, i.e. it presents a body centered cubic structure like that of niobium. Alternatively, this chemical element has an alpha-generating effect.

For example, with a fiber made of silicon carbide (SiC) that is embedded in a matrix of Ti-6242 titanium alloy (first alloy) having a melting temperature T_{F1} of 1670° C., the second alloy is selected to be a titanium niobium alloy (Ti—Nb) comprising 51% by weight of Ti and 49% by weight of Nb, and having a melting temperature T_{F2} of 1870° C.

During pre-coating, the second alloy wets the fiber 10 well because the second speed V2 is slow (equal to about 1 m/s or slower), and a coating 225 of this second alloy is formed over the entire surface of the fiber 10 with a constant thickness of 4 μm, and this coating adheres to the fiber 10. This coating 225 is made up of grains of beta phase titanium with the carbides TiC and NbC at the boundaries between grains.

During the subsequent coating, the Ti—Nb alloy is well wetted by the titanium alloy. Little niobium diffuses into the titanium, thereby avoiding the appearance of a supercooling phenomenon such as a eutectic phenomenon (a portion of the alloy going to the liquid state).

Advantageously, the niobium content in the second alloy is greater than 3% in order to obtain some beta phase in the titanium of the second alloy (below which content the titanium is entirely in alpha phase), and less than 50% in order to avoid overheating the fiber 10 during pre-coating (since the melting temperature T_{F2} increases with the percentage of niobium).

Alloys other than Nb—Ti that are suitable for pre-coating SiC fibers when the first alloy is a titanium alloy are alloys of titanium and one (or more) additional element(s) present in the first alloy. The melting temperature of the additional element should be higher than the melting temperature T_{F1} of the first alloy. Advantageously, the additional element does not form a eutectic with titanium, and on the contrary it forms a total solid solution (a single solid phase below the solidus temperature in the phase diagram), or else it generates a peritectic reaction.

Such additional elements are as follows: zirconium (Zr), chromium (Cr), vanadium (Va), hafnium (Hf), molybdenum (Mo), tantalum (T), rhenium (Re), and tungsten (W).

Thus, and advantageously, when the first alloy is Ti-6242 titanium alloy, the second alloy (or pre-coating) includes at least one of the elements in the group constituted by Nb, Zr, Cr, V, Hf, Mo, Ta, Re, W.

The second alloy may thus be an alloy of titanium with a plurality of elements from this group, such as Ti—Nb—Zr, Ti—Nb—V, Ti—Ta—Zr.

In a variant, after the fiber 10 has been pre-coating with the second alloy and before the fiber 10 is coated with the first alloy, the fiber 10 (with its coating of second alloy) is subjected to a second pre-coating operation with a third alloy having a melting temperature T_{F3} that is strictly lower than the melting temperature T_{F2} of the second alloy and strictly higher than the melting temperature T_{F1} of the first alloy.

Thus, after step k), and before step a), the following steps are performed:

l) providing a third mass of a third metal alloy having a melting temperature T_{F3} that is strictly lower than the melting temperature T_{F2} of the second alloy and that is strictly higher than the melting temperature T_{F1} of the first alloy;

m) heating the third mass to above its melting temperature so that the third alloy is in the liquid state and occupies a space E3, and then moving the fiber from upstream to downstream in translation through the third alloy, this translation taking place at a third speed V3 that is faster than the second speed V2, which is slower than the first speed V1, and that is such that the condition under which the third alloy is taken up during this third translation lies under visco-capillary conditions, such that the fiber becomes covered over a portion of its length (already coated in the second alloy), by a coating of the third alloy presenting a thickness that is not zero and occupying its entire periphery; and

n) cooling the coating of the third alloy until it becomes solid.

The method of the invention is applicable to any combination of fibers, in particular ceramic fibers, and of metal alloy constituting the matrix in which the fibers are embedded.

1-6. (canceled)

7. A method of depositing a coating of a first metal alloy on a fiber extending in a main direction, the method comprising:
a) providing a first mass of a first metal alloy and heating the first mass to above its first melting temperature so that the first metal alloy is in the liquid state and occupies a first space; and
b) causing the fiber to move in translation from upstream to downstream through the liquid first mass along a direction in which the fiber extends at a first speed such that the fiber becomes covered over at least a portion of its length by a coating of the first alloy, which coating presents a non-zero thickness over an entire periphery of the fiber in a plane perpendicular to the main direction;
further comprising, prior to a):
i) providing a second mass of a second metal alloy having a second melting temperature that is strictly higher than the first melting temperature of the first alloy;
j) heating the second mass to above its second melting temperature so that the second alloy is in the liquid state and occupies a second space, and then moving the fiber in translation from upstream to downstream through the second alloy, the moving taking place at a second speed such that a condition under which the second alloy is taken up during the moving lies under visco-capillary conditions, such that the fiber becomes covered, over the portion of its length, by a coating of the second alloy, which coating presents a non-zero thickness over the entire periphery of the fiber; and
k) cooling the coating of the second alloy until the coating becomes solid.

8. A method according to claim 7, wherein the second coating speed is strictly slower than the first coating speed.

9. A method according to claim 7, wherein the second alloy does not form embrittling phases with the first alloy.

10. A method according to claim 9, wherein the second alloy contains at least one chemical element that is present in the first alloy.

11. A method according to claim 7, wherein the first alloy is a titanium alloy.

12. A method according to claim 11, wherein the first alloy is Ti-6242 titanium alloy, the second alloy including at least one of elements from the group constituted by Nb, Zr, Cr, V, Hf, Mo, Ta, Re, and W.
